(19) United States
(12) Patent Application Publication
(10) Pub. No.: US 2008/0223988 A1
(43) Pub. Date: Sep. 18, 2008

(54) System For Inerting a Compartment of a self-Propelled Vehicle, Especially an Aircraft

(76) Inventors: Stephane Lessi, Newark (DE); Olivier Vandroux, Grenoble (FR)

Correspondence Address: AIR LIQUIDE;Intellectual Property, 2700 POST OAK BOULEVARD, SUITE 1800, HOUSTON, TX, 77056, US

(21) Appl. No.: 11/816,499

(22) PCT Filed: Jan. 20, 2006
(86) PCT No.: PCT/FR2006/050032

§ 371 Date: May 12, 2008

(30) Foreign Application Priority Data
Feb. 16, 2005 (FR) 0550439

(51) Int. Cl. B64D 37/32; B01D 53/86

(52) U.S. Cl. 244/135 R; 422/177; 422/173

(57) ABSTRACT

The invention relates to a system for inerting a compartment of a vehicle, typically a fuel tank (1) for supplying the gas turbine (3) of an aircraft with fuel. Said system comprises a filtering device (5) arranged between the compressed air source (3) and the device for separating gas from the air (8), which typically comprises polymer membranes, said filtering device being provided with at least one catalysis section (51) for the heat decomposition of pollutants that may be present in a vapour phase in the compressed air, and at least one HEPA filtering section (52, 53). The inventive system can be especially used to inert a fuel tank for a civil or military aviation aircraft.

The present invention relates to systems for inerting compartments of self-propelled vehicles, of the type comprising, between an inlet end that can be connected to a compressed air source belonging to the vehicle and at least one outlet that can be connected to the compartment that is to be inerted, at least one device for separating the gases in the air.

Self-propelled vehicles, particularly motor vehicles and aircraft, are frequently operated in particularly contaminated surroundings, the surrounding atmosphere being rich in particulates and volatile organic compounds, most often known by their English-language abbreviation VOCs. Now, devices for separating the gases in the air in general, and on-board devices in particular, particularly permeation-membrane devices, are also sensitive to these contaminants which soon reduce their efficiency and/or their life.

It is an object of the present invention to propose an inerting system of the type defined above that makes it possible, while at the same time complying with the weight and bulk requirements of on-board equipment, to adequately filter out the contaminants present in the surrounding air, particularly contaminants in the vapor phase, and therefore considerably lengthen the life of the inerting system.

To do this, according to one feature of the invention, the inerting system comprises, between the compressed air inlet end and the device for separating the gases in the air, a filtering device comprising at least one catalysis section for breaking down any contaminants, particularly organic contaminants, that might be present, in vapor phase, in the compressed air.

According to other particular features of the invention:
the catalysis section comprises a cellular structure supporting at least one layer of a catalytic precious metal;
the system comprises, between the filtering device and the separation device, a cooling device for cooling the filtered compressed air;
the filtering device further comprises at least one particulate filtering section, typically of the particle-arresting HEPA (High Efficiency Particulate Air) type;
the filtering device comprises means for heating the catalysis section;
the separation device is of the polymer membrane type;
the compartment that is to be inerted is a fuel tank; and
the vehicle is an aircraft.

The invention also relates to an aircraft provided with such an inerting system.

Other features and advantages of the invention will become apparent from the following description of some embodiments, which are given by way of entirely non-limiting illustration, with reference to the attached drawings, in which:

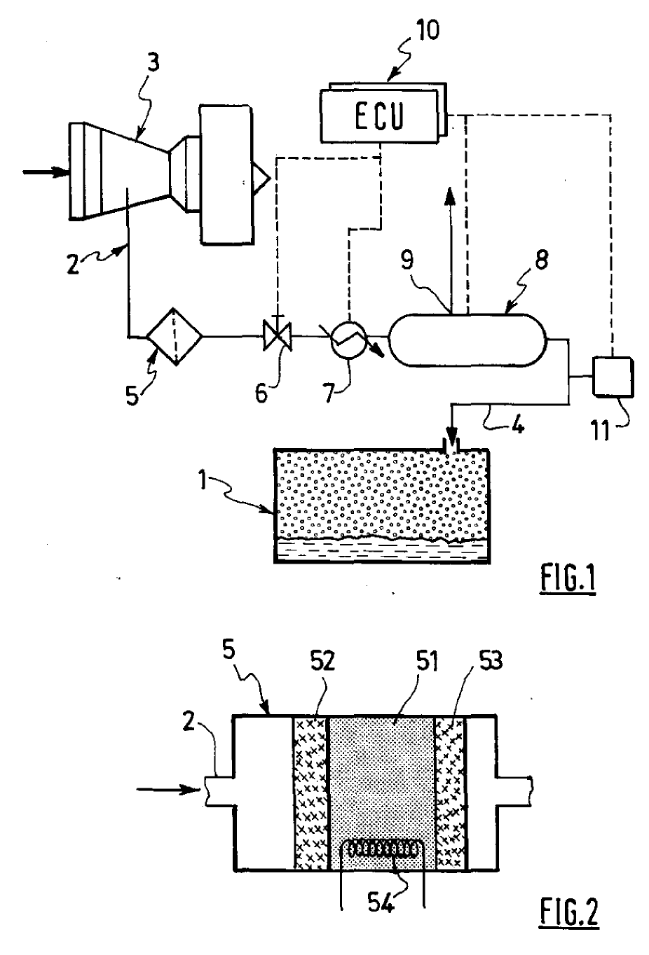

FIG. 1 is a schematic view of one embodiment of a system for inerting an aircraft fuel tank according to the invention; and

FIG. 2 is a partially sectioned schematic view of a filtering device used in the inerting system according to the invention.

In the particular embodiment depicted in FIG. 1, which relates to the inerting of a civilian or military aircraft (not depicted) fuel tank 1, an inerting system according to the invention comprises a line for producing an oxygen-lean gaseous mixture between an inlet end 2 connected to a compression stage of an aircraft propulsion turbomachine 3, and an impure-nitrogen outlet end 4 opening into the gaseous headspace of the tank 1.

The line comprises, from the upstream end downstream, a filtering device 5, a flow-regulating solenoid valve 6, a heat exchanger/cooler 7 and a device 8 for separating the gaseous constituents of the air, typically consisting of bundles of polymer fibers capable of separating the nitrogen from the oxygen in the air and supplying, in the outlet 4, a very oxygen-lean gaseous mixture. The separation device 8 further comprises an outlet 9 for an oxygen-enriched gaseous mixture which is discharged into the surrounding atmosphere or used in air-conditioning or combustion systems.

The inerting system further comprises an electronic control unit 10 functionally connected to the solenoid valve 6 and to the exchanger 7 and to a sensor 11 that senses the residual oxygen content in the outlet end 4.

According to one aspect of the invention, the filtering device 5 comprises a catalysis section 51 comprising at least one catalytic precious metal, typically platinum, possibly palladium or rhodium, deposited on a porous and/or cellular metallic support, for example of the honeycomb type, so as to break down the VOCs through the action of heat into carbon dioxide and water. The filtering device 5 further comprises at least one, and advantageously 2, HEPA filtering sections 52, 53 advantageously of the pleated fiberglass filter type, so as to arrest the particles upstream and downstream of the catalysis section 51.

For application to vehicles comprising a turbomachine, particularly aircraft, the device according to the invention advantageously makes good use of the relatively high temperatures of the compressed air (generally available at between 180° C. and 250° C.) leaving the compression stage of the turbomachine 3, as this encourages catalyst activity and improves contaminant conversion efficiency. As an alternative, in order to improve the efficiency of the catalysis section 51 still further, an additional heating device 54, either electrical or of the heat exchanger type using hot gases from the turbomachine, may be associated with the catalysis section, therein, as depicted, or around it, in a heating jacket. The cooler 7, which typically uses a counter-current flow of ambient air, is engineered to return the temperature of the filtered compressed air in the region of the separator 8 to a value no higher than 80° C.

Although the invention has been described in conjunction with some particular embodiments, it is not restricted thereto but can be modified and varied in ways that will be apparent to the person skilled in the art within the scope of the claims which follow.

1-9. (canceled)

10. A system for inerting a compartment of a self-propelled vehicle comprising, between an inlet end that can be connected to a compressed air source belonging to the vehicle and at least one outlet that can be connected to the compartment that is to be inerted, at least one device for separating the gases in the air, wherein it comprises, between the inlet end and the separation device, a filtering device comprising at least one catalysis section for breaking down any contaminants that might be present, in vapor phase, in the compressed air.

11. The system of claim 10, wherein the catalysis section comprises a cellular structure supporting at least one layer of a catalytic precious metal.

12. The system of claim 10, wherein the filtering device further comprises at least one particulate filtering section.

13. The system of claim 10, wherein it comprises, between the filtering device and the separation device, a cooling device for cooling the filtered compressed air.

14. The system of claim 10, wherein the separation device is of the polymer membrane type.

15. The system of claim 10, wherein the filtering device comprises means for heating the catalysis section.

16. The system of claim 10, wherein the compartment that is to be inerted is a fuel tank.

17. The system of claim 10, wherein the vehicle is an aircraft.

18. An aircraft provided with a compartment-inerting system of claim 10.
